(19) United States
(12) Patent Application Publication
(10) Pub. No.: US 2021/0110966 A1
(43) Pub. Date: Apr. 15, 2021

(54) MAGNET WITH MULTIPLE DISCS

(71) Applicant: Power Integrations, Inc., San Jose, CA (US)

(72) Inventor: William M. Polivka, Campbell, CA (US)

(73) Assignee: Power Integrations, Inc., San Jose, CA (US)

(21) Appl. No.: 16/869,955

(22) Filed: May 8, 2020

Related U.S. Application Data
(60) Provisional application No. 62/912,969, filed on Oct. 9, 2019.

(51) Int. Cl. H01F 27/32; H01F 3/06; H01F 27/26

(52) U.S. Cl. CPC H01F 27/324; H01F 27/263; H01F 3/06

(57) ABSTRACT

A magnet comprising a center disc having a center disposed as a center of the magnet, a face of the center disc is substantially perpendicular to a central axis of the magnet. The magnet further comprises a first plurality of outer discs disposed around the center disc in a bundled rod construction, a face of each of the first plurality of outer discs substantially perpendicular to the central axis of the magnet, wherein the center disc and each disc of the first plurality of outer discs is electrically insulated from every other disc.

This application claims the benefit of U.S. Provisional Application No. 62/912,969, filed Oct. 9, 2019, which is incorporated in its entirety herein by reference.

### BACKGROUND OF THE INVENTION

### 1. Field of the Invention The present invention relates generally to magnets, and more specifically to magnets which could be used in energy transfer elements of power converters.

### 2. Discussion of the Related Art

Electronic devices use power to operate. Switched mode power converters are commonly used due to their high efficiency, small size and low weight to power many of today's electronics. Conventional wall sockets provide a high voltage alternating current. In a switching power converter, a high voltage alternating current (ac) input is converted to provide a well-regulated direct current (dc) output through an energy transfer element. In operation, a switch is utilized to provide the desired output by varying the duty cycle, varying the switching frequency, or varying the number of pulses per unit time of the switch in a switched mode power converter.

The energy transfer element for a switched mode power converter generally includes coils of wire wound around a core of magnetically active material (such as ferrite or steel). For energy transfer elements such as a transformer, the energy transfer element can also include a structure called a bobbin which provides support for the coils of wire and provides an area for the core to be inserted so the coils of wire can encircle the core. The core provides a path for a magnetic field generated by an electrical current flowing through the coils of wire. There is often a discrete region of non-magnetically active material introduced in the path of the magnetic field provided by the core, typically referred to as a gap. The length of the gap may be chosen to manage the distribution of energy in the energy transfer element. The non-magnetically active material is typically air, and the gap is often referred to as an air gap, although the gap may contain other material that is not magnetically active such as paper or varnish. The energy transfer element could also include a magnet, such as a permanent magnet, utilized with the core to provide flux density offset for the core of magnetically active material. The magnet could be inserted into the air gap of an energy transfer element. However, due to the changing magnetic fields of an energy transfer element, the magnet may be susceptible to eddy currents. The eddy current can produce an undesirable power dissipation in the magnet.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified. p FIG. 1A is a perspective view of a composite disc magnet with circular discs, in accordance with embodiments of the present disclosure.

FIG. 1B is a perspective view of a single disc of the composite disc magnet of FIG. 1A in the presence of a changing magnetic field, in accordance with embodiments of the present disclosure.

FIG. 1C is a perspective view of the composite disc magnet of FIG. 1A illustrating an outer boundary, in accordance with embodiments of the present disclosure.

FIG. 1D is a planar view of the composite disc magnet of FIG. 1A with an insulating fill, in accordance with embodiments of the present disclosure.

FIG. 1E is a perspective view of a bundled rod construction with circular rods which may be used to create the composite disc magnet of FIG. 1A, in accordance with embodiments of the present disclosure.

FIG. 2A is a perspective view of a composite disc magnet with hexagonal discs, in accordance with embodiments of the present disclosure.

FIG. 2B is a perspective view of a single hexagonal disc of the composite disc magnet of FIG. 2A in the presence of a changing magnetic field, in accordance with embodiments of the present disclosure.

FIG. 2C is a perspective view of the composite disc magnet of FIG. 2A illustrating an outer boundary, in accordance with embodiments of the present disclosure.

FIG. 2D is a planar view of the composite disc magnet of FIG. 2A with an insulating fill, in accordance with embodiments of the present disclosure.

FIG. 2E is a perspective view of a bundled rod construction with hexagonal rods which may be used to create the composite disc magnet of FIG. 2A, in accordance with embodiments of the present disclosure.

FIG. 3A is a planar view of a composite disc magnet with triangular discs, in accordance with embodiments of the present disclosure.

FIG. 3B is a planar view of another example of a composite disc magnet with triangular discs, in accordance with embodiments of the present disclosure.

FIG. 3C is a planar view of a composite disc magnet with circular discs of varying sizes, in accordance with embodiments of the present disclosure.

FIG. 4A is a flow chart of one example of creating a composite disc magnet, in accordance with embodiments of the present disclosure.

FIG. 4B is a flow chart of another example of creating a composite disc magnet, in accordance with embodiments of the present disclosure.

FIG. 5A is a perspective view of a core with an air gap, in accordance with embodiments of the present disclosure.

FIG. 5B is a planar view of the core of FIG. 5A, in accordance with embodiments of the present disclosure.

FIG. 5C is an exploded view of the core of FIG. 5A with a composite disc magnet, in accordance with embodiments of the present disclosure.

FIG. 6A is a perspective view of a substrate and a plurality of magnetic discs, in accordance with embodiments of the present disclosure.

FIG. 6B is a planar view of the substrate and an example composite disc magnet of FIG. 6A, in accordance with embodiments of the present disclosure.

FIG. 6C is a planar view of the substrate and an example tiled disc magnet of FIG. 6A, in accordance with embodiments of the present disclosure.

FIG. 7 is a flow chart of one example of creating a composite disc magnet or a tiled magnet on a substrate, in accordance with embodiments of the present disclosure.

FIG. 8A is a perspective view of an example core with an air gap, in accordance with embodiments of the present disclosure.

FIG. 8B is a perspective view of another example core with an air gap, in accordance with embodiments of the present disclosure.

FIG. 8C is planar view of an example composite disc magnet on a square center post, in accordance with embodiments of the present disclosure.

FIG. 8D is planar view of an example tiled disc magnet on a square center post, in accordance with embodiments of the present disclosure.

FIG. 8E is planar view of a further example composite disc magnet on a square center post, in accordance with embodiments of the present disclosure.

FIG. 8F is planar view of a further example tiled disc magnet on a square center post, in accordance with embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

An energy transfer element could utilize a magnet to provide flux density offset for the core of magnetically active material. The time-varying magnetic field of an energy transfer element used with a switched mode power converter generates an electric field which drives an eddy current in the magnet. Although a permanent magnet when magnetized may have a relative magnetic permeability near unity and therefore be considered non-magnetically active, the material may have a relatively high electrical conductivity that allows non-negligible current in the presence of an electric field. Eddy currents in an electrically conductive material can generate power loss for an energy transfer element. Previous solutions have included laminated magnets in which thin sheets or slices of a magnet are assembled into a larger piece. For laminated magnets, the sheets or slices are generally assembled such that the face of the sheet or slice is parallel to the direction of the magnetic field. Examples of the present disclosure include a composite disc magnet or a tiled disc magnet which may reduce the power loss generated by eddy currents.

Embodiments of the present disclosure include a composite disc magnet in which a plurality of discs are attached to each other within an outer boundary of the composite disc magnet. Each disc may comprise a magnetically active material, initially unmagnetized, and then magnetized after assembly to create a composite permanent magnet. In one embodiment, the face of each disc is a plane which is perpendicular to a central axis of the composite disc magnet. Further, the face of each disc is perpendicular to an expected magnetic field. In one example, the top surface or bottom surface of the disc may be considered a “face,” and the top surface and bottom surface are both planes which are perpendicular to the central axis. The outer surface of each disc, e.g. the top surface, bottom surface, and the surface which couples the top surface to the bottom surface, may be coated with an electrically insulating material. The coating may prevent conduction between each disc. The gaps between the discs may be filled with an electrically insulating material to the outer boundary of the composite disc magnet. The discs may be variable in shape, such as circular, hexagonal, triangular, pie-shaped, etc. Further, the plurality of discs may be of equal or variable size. In one embodiment, the composite disc magnet may include seven circular discs of equal diameter with the diameter of each individual circular disc is substantially one-third of the diameter of the outer boundary of the composite disc magnet. In another embodiment, the composite disc magnet may include seven hexagonal discs of equal size within an outer boundary of the composite disc magnet. Further, the composite disc magnet may be assembled separately or assembled onto a substrate.

Embodiments of the present disclosure also include a tiled disc magnet in which a plurality of discs are attached onto a substrate in a desired pattern. However, the tiled discs may not necessarily contact each other in those embodiments. Each disc may comprise a magnetically active material, initially unmagnetized, and then magnetized after assembly onto the substrate to create a composite permanent magnet. In one embodiment, the face of each disc is a plane which is perpendicular to a central axis of the substrate. Further, the face of each disc is perpendicular to an expected magnetic field.

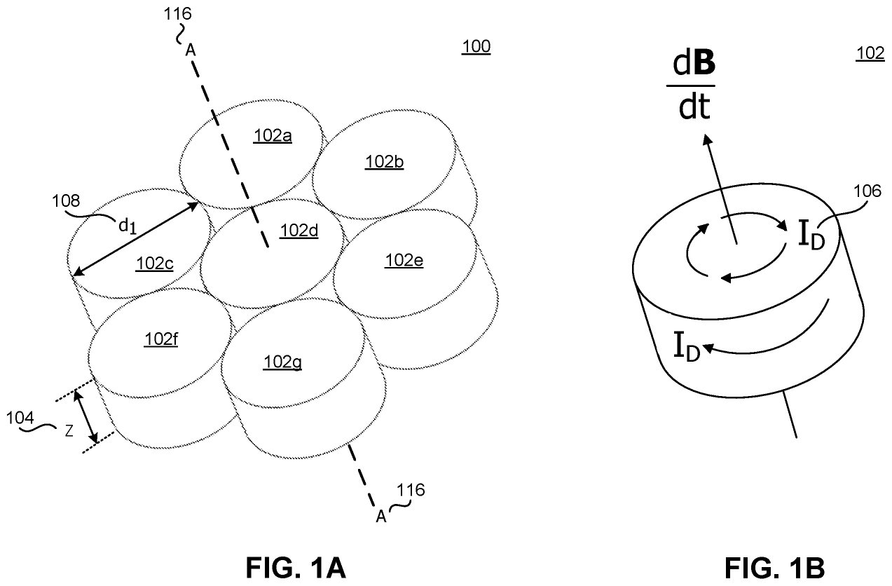

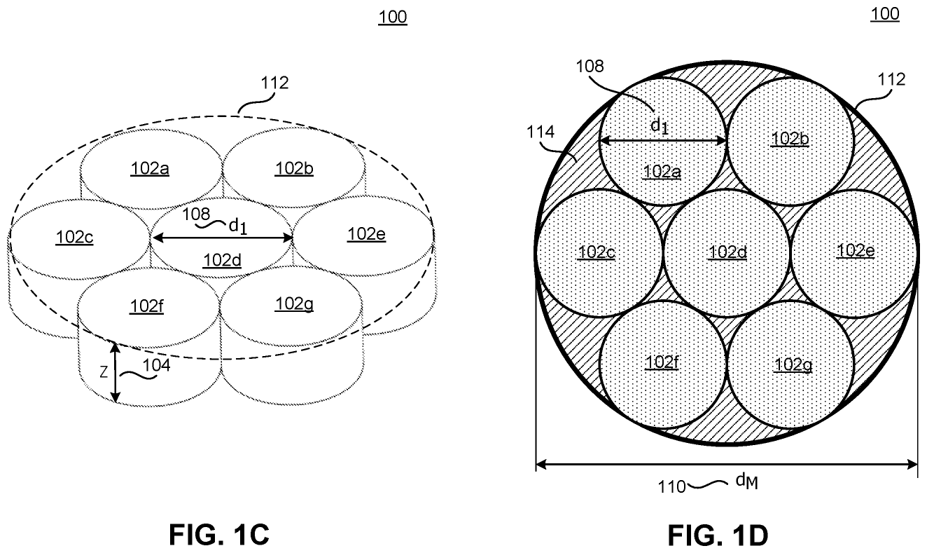

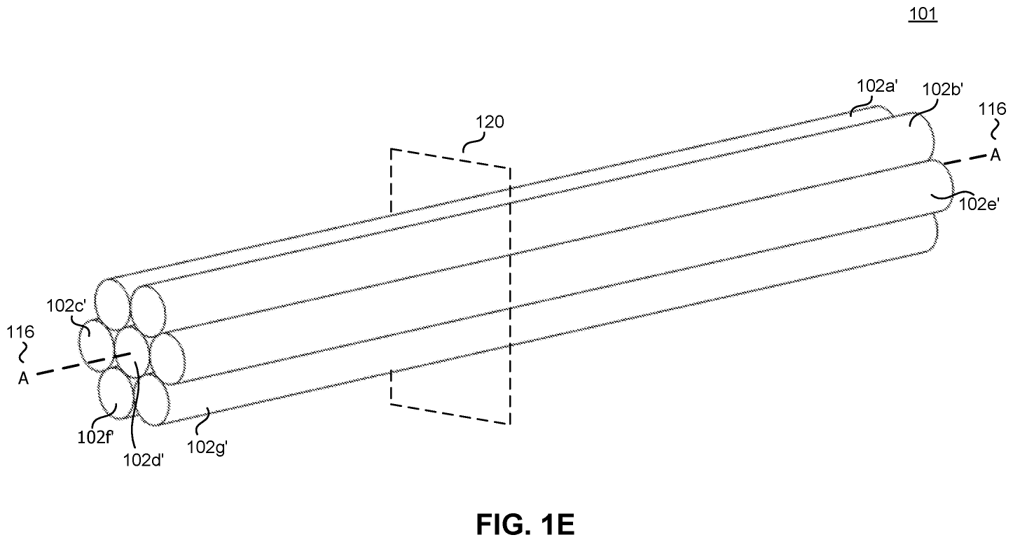

FIG. 1A illustrates a perspective view of a composite disc magnet 100 with discs 102a, 102b, 102c, 102d, 102e, 102f, and 102g. Each of the discs 102a, 102b, 102c, 102d, 102e, 102f, and 102g is circular in shape and may comprise a magnetically active material utilized to create a permanent magnet. In other words, the face of each disc 102a, 102b, 102c, 102d, 102e, 102f, and 102g is substantially a circle. Or in other words, the top surface and bottom surface of each disc 102a, 102b, 102c, 102d, 102e, 102f, and 102g is substantially a circle. As shown, the top surface and bottom surface are planar. Each circular disc 102a, 102b, 102c, 102d, 102e, 102f, and 102g has a diameter d₁ 108 and depth Z 104. In other words, the top surface and bottom surface of each disc 102a, 102b, 102c, 102d, 102e, 102f, and 102g has a diameter d₁ 108. The discs 102a, 102b, 102c, 102d, 102e, 102f, and 102g are assembled around an axis A 116. In other words, the discs 102a, 102b, 102c, 102d, 102e, 102f, and 102g are assembled such that the plane of the face of each disc 102a, 102b, 102c, 102d, 102e, 102f, and 102g is perpendicular to an axis A 116. In the embodiments shown, the top surface and the bottom surface of discs 102a, 102b, 102c, 102d, 102e, 102f, and 102g may be considered a face of the disc. The axis A 116 may be the central axis of the composite disc magnet 100 and may further represent the expected direction of an external magnetic field which the composite disc magnet 100 may be exposed to. In embodiments of a composite disc magnet, the discs 102a, 102b, 102c, 102d, 102e, 102f, and 102g are touching or otherwise contacting its neighboring discs. As such, in one embodiment, the discs 102a, 102b, 102c, 102d, 102e, 102f, and 102g are coated with an electrically insulating material to prevent current conduction between discs 102a, 102b, 102c, 102d, 102e, 102f, and 102g.

The embodiment shown in FIG. 1A illustrates seven discs. The outer rows each include two discs (102a, 102b and 102f, 102g) while the middle row includes three discs (102c, 102d, and 102e). Disc 102d is shown as the center disc for the composite disc magnet 100 with discs 102a, 102b, 102c, 102e, 102f, and 102g substantially surrounding disc 102d. In the example shown, discs 102d contacts or otherwise touches discs 102a, 102b, 102c, 102e, 102f, and 102g.

In one embodiment, the discs 102a, 102b, 102c, 102d, 102e, 102f, and 102g comprise a magnetic material such as neodymium iron boron (NdFeB), samarium cobalt (SmCo), aluminum nickel cobalt (AlNiCo), or nickel boron (NiB). The discs 102a, 102b, 102c, 102d, 102e, 102f, and 102g may also comprise a ceramic or ferrite material. Further, in one embodiment the discs 102a, 102b, 102c, 102d, 102e, 102f, and 102g comprise an electrically conductive magnetic material mixed uniformly with an electrically insulating binder. Each of the discs 102a, 102b, 102c, 102d, 102e, 102f, and 102g may be shaped by either compression bonding or sintered bonding. However, it should be appreciated that other forms of bonding could be utilized.

In one embodiment of assembly, assembly begins with individual discs 102a, 102b, 102c, 102d, 102e, 102f, and 102g. Initially, the discs 102a, 102b, 102c, 102d, 102e, 102f, and 102g are not magnetized. The individual discs 102a, 102b, 102c, 102d, 102e, 102f, and 102g may be coated with insulating material and then glued or otherwise attached together. If the initial depth of discs 102a, 102b, 102c, 102d, 102e, 102f, and 102g is greater than target depth Z, the discs 102a, 102b, 102c, 102d, 102e, 102f, and 102g may undergo a process similar to wafer backgrinding to reduce the depth of discs 102a, 102b, 102c, 102d, 102e, 102f, and 102g. The gaps of the composite disc magnet 100 may optionally be filled with insulating material. Once assembled, the composite disc magnet 100 is magnetized. In another embodiment, the individual discs may be mounted to a substrate or other desired surface, rather than glued together. For this example, a pick-and-place machine may be used to mount the individual discs to a substrate. The machine could apply drops of adhesive in the proper pattern and place the individual discs on the drops of adhesive to form the composite disc magnet 100. In one example, the substrate may be a portion of a ferrite core for an energy transfer element.

In another example of assembly, further illustrated with respect to FIG. 1E, assembly begins with a plurality of individual rods. In one example, the length or depth of the rod is greater than the depth of a disc. It should be appreciated that a disc may be considered a shortened rod. In one example, a rod may be considered a disc when the length of the rod is its smallest dimension. Initially the individual rods of magnetic material are not magnetized. The individual rods may be coated with insulating material and then glued or otherwise attached together in a bundled rod construction 101. The bundled rod construction 101 can then be sliced with depth Z 104 to result in the composite disc magnet 100. The gaps of the composite disc magnet 100 may optionally filled with insulating material. Once assembled, the composite disc magnet 100 is magnetized.

FIG. 1B illustrates a perspective view of a single disc 102 of the composite disc magnet 100. The disc 102 is one example of any of discs 102a, 102b, 102c, 102d, 102e, 102f, and 102g. The face of disc 102 is substantially a circle. For the example illustrated, a time-varying magnetic field is shown as perpendicular to the circular face of disc 102. The time-varying magnetic field (dB/dt) may be produced externally and independently from the composite disc magnet 100, such as magnetic field which is produced from a current in an energy transfer element of a power converter. The time-varying magnetic field (dB/dt) generates a corresponding electric field which drives carriers of electric charge, known as an eddy current, through a material. Eddy current ID 106 due to the time-varying magnetic field (dB/dt) is shown as flowing clockwise around the face of disc 102 and clockwise around the side of disc 102. Referring back to FIG. 1A, a time-varying magnetic field would produce a corresponding eddy current in each of discs 102a, 102b, 102c, 102d, 102e, 102f, and 102g. The smaller diameter of each individual disc 102a, 102b, 102c, 102d, 102e, 102f, and 102g increases the effective resistivity of the composite disc magnet 102 as compared to the resistivity of a magnet from a single disc of equivalent size to the composite disc magnet 102. With the increased effective resistivity, the power loss from a composite disc magnet 102 should be less than the power loss from a magnet formed from a single disc of equivalent size to the composite disc magnet 102.

FIG. 1C illustrates another perspective view of the composite disc magnet 100 with discs 102a, 102b, 102c, 102d, 102e, 102f, and 102g housed within an outer boundary 112 (shown as a dashed line) of the composite disc magnet 100. In one embodiment, the outer boundary 112 is substantially a circle. However, it should be appreciated that the outer boundary 112 could have a different shape. As mentioned above, each disc 102a, 102b, 102c, 102d, 102e, 102f, and 102g has a circular face. Or in other words, each disc 102a, 102b, 102c, 102d, 102e, 102f, and 102g has a circular top and bottom surface which is planar. The composite disc magnet 100 and each of discs 102a, 102b, 102c, 102d, 102e, 102f, and 102g is shown as having a depth Z 104. Discs 102a, 102b, 102c, 102d, 102e, 102f, and 102g further have a diameter d₁ 108. Disc 102d is at the center of the composite disc magnet 100 and is surrounded by discs 102a, 102b, 102c, 102e, 102f and 102g.

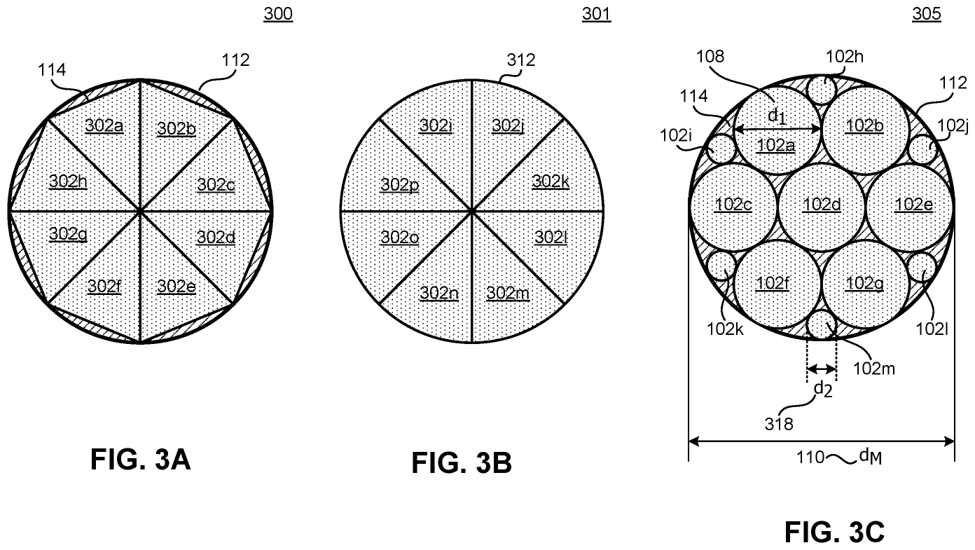

FIG. 1D illustrates a planar view of the composite disc magnet 100 with discs 102a, 102b, 102c, 102d, 102e, 102f, and 102g housed within an outer boundary 112 (shown as a bold line) of the composite disc magnet 100. The planar view shown may be along axis A 116. In the example of FIG. 1D, the axis A 116 would be coming out of the page. In one embodiment, the outer boundary 112 is substantially a circle. Discs 102a, 102b, 102c, 102d, 102e, 102f, and 102g further have a diameter d₁ 108. The composite disc magnet 100 has an overall diameter d_{M} 110. In one embodiment, the diameter d_{M} 110 of the composite disc magnet 100 is substantially three times the diameter d₁ 108 of discs 102a, 102b, 102c, 102d, 102e, 102f, and 102g. However, it should be appreciated that smaller or larger discs may be used within the circle of diameter d_{M}, which could change the number of discs within the outer boundary 112. Further, discs of various sizes may be used within the circle of diameter d_{M}, as shown with respect to FIG. 3C. Optionally, the composite disc magnet 100 may also include an insulating fill 114. As shown, the gaps between each disc 102a, 102b, 102c, 102d, 102e, 102f, and 102g and the outer boundary 112 may be filled with an insulating fill 114. The material used for the insulating fill 114 may be electrically insulating. In one embodiment, the insulating fill 114 may comprise the same or similar material to the adhesive which bonds the discs 102a, 102b, 102c, 102d, 102e, 102f, and 102g together. For example, cyanoacrylate (e.g. super glue) such as for example Loctite 414 could be used for the adhesive, insulating coating and the insulating fill 114.

FIG. 1E illustrates a perspective view of a bundled rod construction 101 with circular rods 102a′, 102b′, 102c′, 102d′, 102e′, 102f′, and 102g′, which may be one embodiment of construction for the composite disc magnet 100 shown in FIGS. 1A, 1B, 1C, and 1D. The individual rods 102a′, 102b′, 102c′, 102d′, 102e′, 102f′, and 102g′, correspond to similarly numbered discs 102a, 102b, 102c, 102d, 102e′, 102f, and 102g, and are gathered and glued or otherwise attached together in a bundled rod construction. In one example, a bundled rod construction may refer to grouping two or more rods together within a boundary, such as outer boundary 112 shown above. Each rod 102a′, 102b′, 102c′, 102d′, 102e′, 102f, and 102g′ may be formed by either compression bonding or sintered bonding. As shown, each rod 102a′, 102b′, 102c′, 102d′, 102e′, 102f′, and 102g′ is substantially cylindrical in shape. The length of rods 102a′, 102b′, 102c′, 102d′, 102e′, 102f′, and 102g′ is substantially parallel with axis A 116. Further, the length of rods 102a′, 102b′, 102c′, 102d′, 102e′, 102f′, and 102g′ is greater than the depth Z 104. Similar to above, rod 102d′ is the center rod of the construction and is surrounded by rods 102a′, 102b′, 102c′, 102e′, 102f′, and 102g′. In one embodiment, the rods 102a′, 102b′, 102c′, 102d′, 102e′, 102f′, and 102g′ are coated with electrically insulating material. To assemble the composite disc magnet 100, the bundled rod construction 101 may be sliced along a plane 120 which is perpendicular to axis A 116. The distance between the slices may be substantially equal to depth Z 104 to result in the composite disc magnet 100. When sliced along plane 120, the cross-sectional view of the bundled rod construction 101 may be substantially the planar view of the composite disc magnet 100 shown in FIG. 1D. It should be appreciated that a disc may be considered a shortened rod. In example, a rod may be considered a disc when the length of the rod is its smallest dimension.

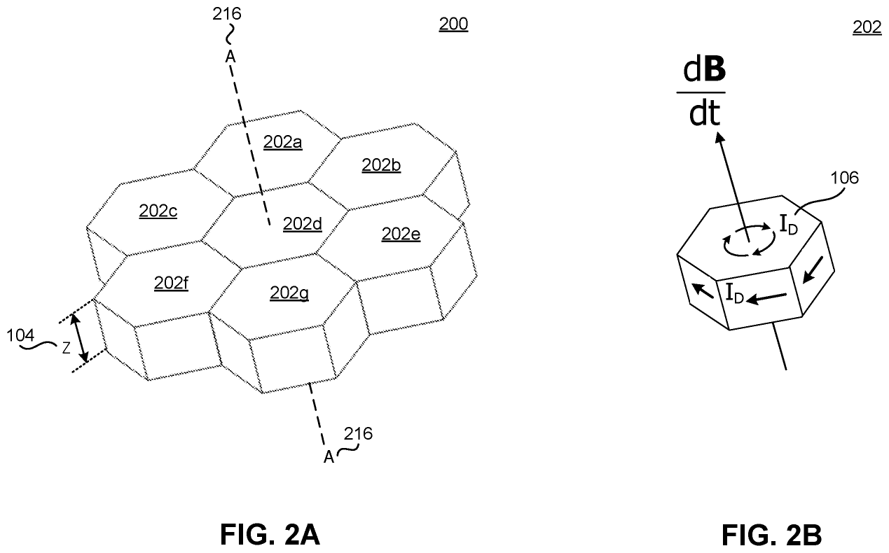

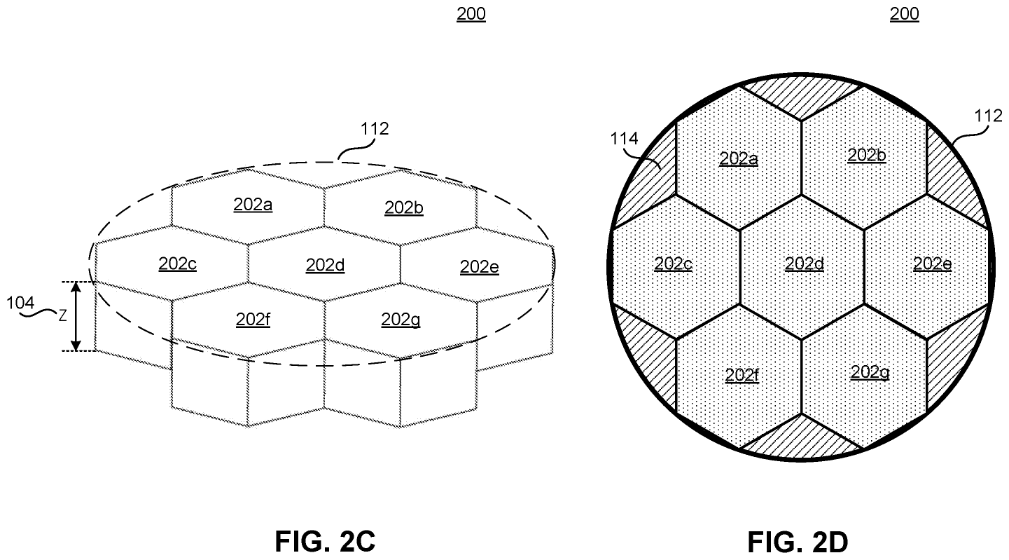

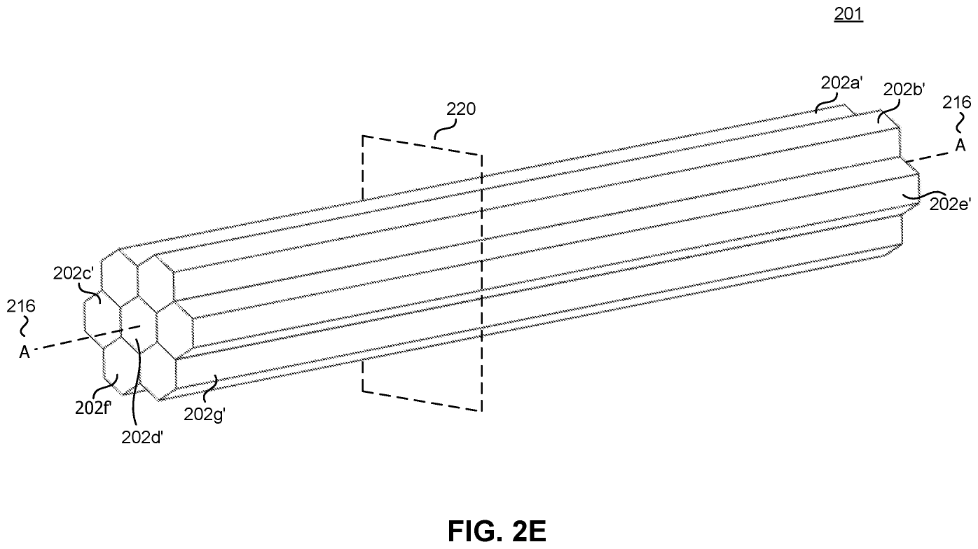

FIG. 2A illustrates a perspective view of a composite disc magnet 200 with discs 202a, 202b, 202c, 202d, 202e, 202f, and 202g. It should be appreciated that the composite disc magnet 200 and corresponding discs are similar to the composite disc magnet 100 and corresponding discs discussed above and may be made of similar materials and assembled in similar ways. One difference however, is each of discs 202a, 202b, 202c, 202d, 202e, 202f, and 202g is hexagonal in shape. In other words, the face of each disc 202a, 202b, 202c, 202d, 202e, 202f, and 202g is substantially a hexagon. Or other words, the top surface and bottom surface of each disc 202a, 202b, 202c, 202d, 202e, 202f, and 202g is substantially a hexagon. Further, the top and bottom surfaces are substantially planar. Each disc 202a, 202b, 202c, 202d, 202e, 202f, and 202g is substantially the same size and has a depth Z 104. The discs 202a, 202b, 202c, 202d, 202e, 202f, and 202g are assembled around axis A 216 such that the plane of the face of each disc 202a, 202b, 202c, 202d, 202e, 202f, and 202g is perpendicular to the axis A 116. As shown, the bottom surface and the top surface of discs 202a, 202b, 202c, 202d, 202e, 202f, and 202g may be considered a face. The axis A 216 may be the central axis of the composite disc magnet 200 and may further represent the expected direction of an external magnetic field to which the composite disc magnet 200 may be exposed. In embodiments of a composite disc magnet 200, the discs 202a, 202b, 202c, 202d, 202e, 202f, and 202g are touching or otherwise contacting their neighboring discs. As such, in one embodiment, the discs 202a, 202b, 202c, 202d, 202e, 202f, and 202g are coated with an electrically insulating material to prevent current conduction between discs 202a, 202b, 202c, 202d, 202e, 202f, and 202g.

The embodiment shown in FIG. 2A illustrates seven hexagonal discs. The outer rows each include two discs (202a, 202b and 202f, 202g) while the middle row includes three discs (202c, 202d, and 202e). Disc 202d is shown as the center disc for the composite disc magnet 200 with discs 202a, 202b, 202c, 202e, 202f, and 202g substantially surrounding disc 202d. Further, disc 202d contacts or otherwise touches discs 202a, 202b, 202c, 202e, 202f, and 202g.

In one embodiment, the discs 202a, 202b, 202c, 202d, 202e, 202f, and 202g comprise a magnetic material such as neodymium iron boron (NdFeB), samarium cobalt (SmCo), aluminum nickel cobalt (AlNiCo), or nickel boron (NiB). The discs 202a, 202b, 202c, 202d, 202e, 202f, and 202g may also comprise a ceramic or ferrite material. Further, in one embodiment the discs 202a, 202b, 202c, 202d, 202e, 202f, and 202g comprise an electrically conductive magnetic material mixed uniformly with an electrically insulating binder. Each of the discs 202a, 202b, 202c, 202d, 202e, 202f, and 202g may be shaped by either compression bonding or sintered bonding.

In one embodiment of assembly, assembly begins with individual discs 202a, 202b, 202c, 202d, 202e, 202f, and 202g. Initially, the discs 202a, 202b, 202c, 202d, 202e, 202f, and 202g are not magnetized. The individual discs 202a, 202b, 202c, 202d, 202e, 202f, and 202g may be coated with insulating material and then glued or otherwise attached together. If the initial depth of discs 202a, 202b, 202c, 202d, 202e, 202f, and 202g is greater than target depth Z, the discs 202a, 202b, 202c, 202d, 202e, 202f, and 202g may undergo a process similar to wafer backgrinding to reduce the depth of discs 202a, 202b, 202c, 202d, 202e, 202f, and 202g. The gaps of the composite disc magnet 200 may optionally be filled with insulating material. Once assembled, the composite disc magnet 200 is magnetized. In another embodiment, the individual discs may be mounted to a substrate or other desired surface, rather than glued together. For this example, a pick-and-place machine may be used to mount the individual discs to a substrate. The machine could apply drops of adhesive in the proper pattern and place the individual discs on the drops of adhesive to form the composite disc magnet 200. In one example, the substrate may be a portion of a ferrite core for an energy transfer element.

In another example of assembly, further illustrated with respect to FIG. 2E, assembly begins with a plurality of individual rods. Initially, the individual rods are not magnetized. The individual rods may be coated with insulating material and then glued or otherwise attached together in a bundled rod construction 201. It should be appreciated that a disc may be considered a shortened rod. In example, a rod may be considered a disc when the length of the rod is its smallest dimension. The bundled rod construction 201 may then be sliced with depth Z 104 to result in the composite disc magnet 200. The gaps of the composite disc magnet 100 may optionally filled with insulating material. Once assembled, the composite disc magnet 200 is magnetized.

FIG. 2B illustrates a perspective view of a single hexagonal disc 202 of the composite disc magnet 200. The disc 202 is one example of any of discs 202a, 202b, 202c, 202d, 202e, 202f, and 202g. The face of disc 202 is substantially a hexagon. A time-varying magnetic field (dB/dt) is shown as perpendicular to the hexagonal face of disc 202. The time-varying magnetic field (dB/dt) may be produced external and independently from the composite disc magnet 200, such as magnetic field which is produced from a current in an energy transfer element of a power converter. The time-varying magnetic field (dB/dt) generates a corresponding electric field which drives carriers of electric charge, known as an eddy current, through a material. Eddy current ID 106 due to the time-varying magnetic field (dB/dt) is shown as flowing clockwise around the face of disc 202 and clockwise along the sides of disc 202. Referring back to FIG. 2A, a time-varying magnetic field would produce a corresponding eddy current in each of discs 202a, 202b, 202c, 202d, 202e, 202f, and 202g. The smaller diameter of each individual disc 202a, 202b, 202c, 202d, 202e, 202f, and 202g increases the effective resistivity of the composite disc magnet 202 as compared to the resistivity of a magnet with a single disc of equivalent size to the composite disc magnet 202. With the increased effective resistivity, the power loss from a composite disc magnet 202 should be less than the power loss from a magnet formed from a single disc of equivalent size to the composite disc magnet 202.

FIG. 2C illustrates another perspective view the composite disc magnet 200 with discs 202a, 202b, 202c, 202d, 202e, 202f, and 202g housed within an outer boundary 112 (shown as a dashed line) of the composite disc magnet 200. In one embodiment, the outer boundary 112 is substantially a circle. However, it should be appreciated that the outer boundary 112 could have a different shape. As mentioned above, each disc 202a, 202b, 202c, 202d, 202e, 202f, and 202g has a hexagonal face. Or in other words, each disc 202a, 202b, 202c, 202d, 202e, 202f, and 202g has a hexagonal top and bottom surface which is planar. The composite disc magnet 200 and each of discs 202a, 202b, 202c, 202d, 202e, 202f, and 202g is shown as having a depth Z 104. Disc 202d is at the center of the composite disc magnet 200 and is surrounded by discs 202a, 202b, 202c, 202e, 202f, and 202g.

FIG. 2D illustrates a planar view of the composite disc magnet 200 with discs 202a, 202b, 202c, 202d, 202e, 202f, and 202g housed within an outer boundary 112 (shown as a bold line) of the composite disc magnet 200. The planar view shown may be along axis A 216. In the example of FIG. 2D, the axis A 216 would be coming out of the page. In one embodiment, the outer boundary 112 is substantially a circle. As shown, seven hexagonal discs are housed within the outer boundary 112. The discs 202a, 202b, 202c, 202d, 202e, 202f, and 202g are substantially the same size and are sized such that the outer discs 202a, 202b, 202c, 202e, 202f, and 202g reach the outer boundary 112. However, it should be appreciated that smaller or larger discs may be used within the outer boundary 112, which could change the number of discs within the outer boundary 112. Optionally, the composite disc magnet 200 may also include an insulating fill 114. As shown, the gaps between each disc 202a, 202b, 202c, 202d, 202e, 202f, and 202g and the outer boundary 112 may be filled with an insulating fill 114. The material used for the insulating fill 114 may be electrically insulating. In one embodiment, the insulating fill 114 may comprise the same or similar material to the adhesive which bonds the discs 202a, 202b, 202c, 202d, 202e, 202f, and 202g together. For example, cyanoacrylate (e.g.

super glue) such as for example Loctite 414 could be used for the adhesive, insulating coating and the insulating fill 114.

FIG. 2E illustrates a perspective view of a bundled rod construction 201 with hexagonal rods 202a′, 202b′, 202c′, 202d′, 202e′, 202f′, and 202g′, which may be one embodiment of construction for the composite disc magnet 200 shown in FIGS. 2A, 2B, 2C, and 2D. The individual rods 202a′, 202b′, 202c′, 202d′, 202e′, 202f′, and 202g′, correspond to similarly numbered discs 202a, 202b, 202c, 202d, 202e, 202f, and 202g, and are gathered and glued or otherwise attached together in a bundled rod construction. In one example, a bundled rod construction may refer to grouping two or more rods together within a boundary, such as outer boundary 112 shown above. Each rod 202a′, 202b′, 202c′, 202d′, 202e′, 202f′, and 202g′ may be formed by either compression bonding or sintered bonding. As shown, each rod 202a′, 202b′, 202c′, 202d′, 202e′, 202f′, and 202g′ is substantially hexagonal in shape. The length of the rods 202a′, 202b′, 202c′, 202d′, 202e′, 202f′, and 202g′ is also substantially parallel with axis A 216. Further, the length of the rods 202a′, 202b′, 202c′, 202d′, 202e′, 202f′, and 202g′ is greater than the depth Z 104. Similar to above, rod 202d′ is the center rod of the bundled rod construction and is surrounded by rods 202a′, 202b′, 202c′, 202e′, 202f′, and 202g′. In one embodiment, the rods 202a′, 202b′, 202c′, 202d′, 202e′, 202f′, and 202g′ are coated with electrically insulating material. To assemble the composite disc magnet 200, the bundled rod construction 201 may be sliced along a plane 220 which is perpendicular to axis A 216. The distance between the slices may be substantially depth Z 104 to result in the composite disc magnet 200. When sliced along plane 220, the cross-sectional view of the bundled rod construction 201 may be substantially the planar view of the composite disc magnet 200 shown in FIG. 2D. It should be appreciated that a disc may be considered a shortened rod. In example, a rod may be considered a disc when the length of the rod is its smallest dimension.

FIGS. 3A, 3B, and 3C illustrate planar views of alternative embodiments for the composite disc magnet with varying shapes for the individual discs. FIG. 3A illustrates a composite disc magnet 300 with triangular discs 302a, 302b, 302c, 302d, 302e, 302f, 302g, and 302h. It should be appreciated that the composite disc magnet 300 with triangular discs is similar to the composite disc magnets and corresponding discs discussed above and may be made of similar materials and assembled in similar ways. For the embodiment shown in FIG. 3A, each of discs 302a, 302b, 302c, 302d, 302e, 302f, 302g, and 302h are triangular in shape. In other words, the face (or the bottom surface or top surface) of each disc 302a, 302b, 302c, 302d, 302e, 302f, 302g, and 302h is substantially a triangle. Each disc 302a, 302b, 302c, 302d, 302e, 302f, 302g, and 302h is substantially the same size and has a depth. Each disc 302a, 302b, 302c, 302d, 302e, 302f, 302g, and 302h is assembled around the center point of the composite disc magnet 300 such that the triangular discs 302a, 302b, 302c, 302d, 302e, 302f, 302g, and 302h radiate from the center point. The discs 302a, 302b, 302c, 302d, 302e, 302f, 302g, and 302h are housed within the outer boundary 112 of the composite disc magnet 300. In the example shown, the outer boundary 112 is substantially a circle. However, it should be appreciated that other shapes can be used for the outer boundary 112. In embodiments of the composite disc magnet 300, the discs 302a, 302b, 302c, 302d, 302e, 302f, 302g, and 302h are touching or otherwise contacting their neighboring discs. Each disc 302a, 302b, 302c, 302d, 302e, 302f, 302g, and 302h may be coated with an electrically insulating material to prevent current conduction between the discs. Further, the gaps between the individual discs and the outer boundary 112 may be filled with insulating fill 114.

FIG. 3B illustrates a composite disc magnet 301 with pie-shaped discs 302i, 302j, 302k, 302l, 302m, 302n, 302o, and 302p. It should be appreciated that the composite disc magnet 301 with pie-shaped discs is similar to the composite disc magnets and corresponding discs discussed above and may be made of similar materials and assembled in similar ways. The face (or bottom surface or top surface) of each disc 302i, 302j, 302k, 302l, 302m, 302n, 302o, and 302p is substantially a pie shape. Each disc 302i, 302j, 302k, 302l, 302m, 302n, 302o, and 302p is substantially the same size and has the same depth and is assembled around the center point of the composite disc magnet 301 such that the pie-shaped discs 302i, 302j, 302k, 302l, 302m, 302n, 302o, and 302p radiate from the center point. In embodiments of the composite disc magnet 301, the discs 302i, 302j, 302k, 302l, 302m, 302n, 302o, and 302p are touching or otherwise contacting its neighboring discs. Each disc 302i, 302j, 302k, 302l, 302m, 302n, 302o, and 302p may be coated with an electrically insulating material. Unlike the composite disc magnet 300 shown in FIG. 3A, however, the outer boundary 312 of the composite disc magnet 301 is defined by the edges of the pie-shaped discs 302i, 302j, 302k, 302l, 302m, 302n, 302o, and 302p.

FIG. 3C is a planar view of a composite disc magnet 305 with circular discs 102a, 102b, 102c, 102d, 102e, 102f, 102g, 102h, 102i, 102j, 102k, 102l, and 102m of varying sizes. It should be appreciated that the composite disc magnet 305 with circular shaped discs of various sizes is similar to the composite disc magnets and corresponding discs discussed above and may be made of similar materials and assembled in similar ways. Further, the composite disc magnet 305 is similar to the composite disc magnet 100 discussed with respect to FIGS. 1A, 1B, 1C, 1D, and 1E. At least one difference, however, is the composite disc magnet 305 also includes discs 102h, 102i, 102j, 102k, 102l, and 102m.

In one embodiment, the face of discs 102a, 102b, 102c, 102d, 102e, 102f, 102g, 102h, 102i, 102j, 102k, 102l, and 102m are substantially circular. Further, the discs 102a, 102b, 102c, 102d, 102e, 102f, 102g, 102h, 102i, 102j, 102k, 102l, and 102m may also have a depth Z. As shown, discs 102a, 102b, 102c, 102d, 102e, 102f, and 102g are substantially the same size with diameter d₁ 108. The composite disc magnet 305 also includes discs 102h, 102i, 102j, 102k, 102l, and 102m, which are substantially the same size with diameter d₂ 318. In one example, diameter d₂ 318 is smaller than diameter d₁ 108. The outer boundary 112 of the composite disc magnet 305 is shown as substantially a circle. However, it should be appreciated that other shapes can be used for the outer boundary 112. Discs 102a, 102b, 102c, 102d, 102e, 102f, 102g, 102h, 102i, 102j, 102k, 102l, and 102m are housed within the outer boundary 112 of the composite disc magnet 305. The composite disc magnet 305 has an overall diameter d_{M} 110. In one embodiment, the diameter d_{M} 110 of the composite disc magnet 205 is substantially three times the diameter d₁ 108 of discs 102a, 102b, 102c, 102d, 102e, 102f, and 102g. In embodiments of the composite disc magnet 305, the discs 102a, 102b, 102c, 102d, 102e, 102f, 102g, 102h, 102i, 102j, 102k, 102l, and 102m are touching or otherwise contacting their neighboring discs. In one embodiment, the discs 102a, 102b, 102c, 102d, 102e, 102f, 102g, 102h, 102i, 102j, 102k, 102l, and 102m are coated with an electrically insulating material. Further, the composite disc magnet 305 may also include an insulating fill 114 (shown in dashed lines). As shown, the gaps between each disc 102a, 102b, 102c, 102d, 102e, 102f, 102g, 102h, 102i, 102j, 102k, 102l, and 102m and the outer boundary 112 may be filled with an insulating fill 114. The material used for the insulating fill 114 may be electrically insulating. Although circular discs are shown, it should be appreciated that other shaped discs of various sizes could be housed within the outer boundary 112 for the composite disc magnet.

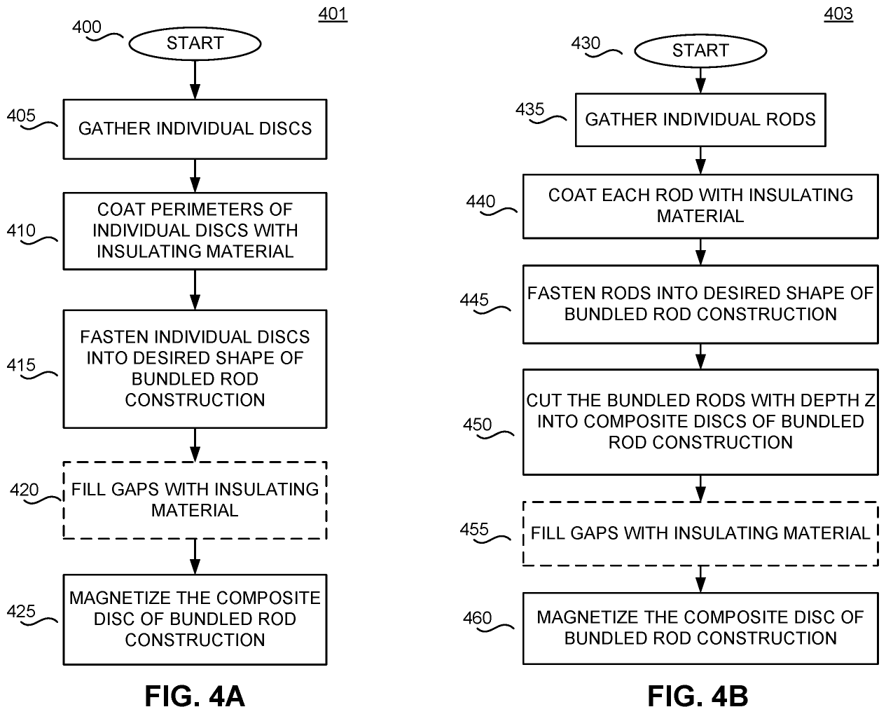

FIG. 4A illustrates process 401, which is one example assembly for a composite disc magnet in accordance with embodiments of the present disclosure. In particular, process 401 illustrates assembly beginning from individual precut discs. The order in which some or all of the process blocks appear in process 401 should not be deemed limiting. Rather, one of ordinary skill in the art having the benefit of the present disclosure will understand that some of the process blocks may be executed in a variety of orders not illustrated, or even in parallel.

The assembly starts at block 400 and proceeds to block 405 where the individual discs are gathered for assembly. Once gathered, the process proceeds to block 410 and the perimeters of the individual discs are coated with an insulating material. In one embodiment, the coating of insulated material may comprise the same or similar material to the adhesive which bonds the disc. For example, cyanoacrylate (e.g. super glue) such as for example Loctite 414 could be used for the adhesive, insulating coating and the insulating fill. In some examples, the insulating coating may comprise a lacquer, such as clear nail polish, or a polymer film, such as Parylene. Further, example process for coating the discs may include individually applying the insulating material with the appropriate tool or chemical vapor deposition of the appropriate insulating material.

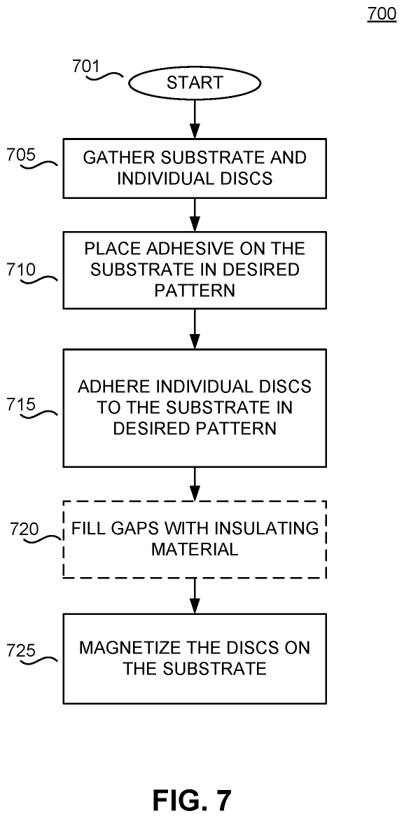

At block 415, the individual discs are gathered into the desired shape of bundled rod construction. In one example, a bundled rod construction may refer to the grouping of the individual discs within an outer boundary with the faces of each disc substantially perpendicular with the central axis of the composite disc magnet. For example, the desired shape may be circular and ergo the outer boundary for the composite disc is circular. Other shapes may include a hexagon, square, rectangle etc. In one embodiment, the individual discs may be fastened together with glue or other adhesive material. For this example, a sheet of paper with an outline of the outer boundary 112 may be covered with a transparent sheet of Mylar. The individual discs may be arranged atop the transparent sheet of Mylar in the desired shape of bundled rod construction, within the outer boundary 112 and then flooded with an adhesive, such as cyanoacrylate. Further, the individual discs may be arranged such that the face of each disc is parallel with the transparent sheet of Mylar and the direction of the central axis of the resultant composite disc magnet would be out of the page. Once the adhesive has cured, the discs may be removed from the Mylar sheet and excess adhesive may be trimmed. In another embodiment, as will be further discussed with respect to FIG. 7, the individual discs may be mounted to a substrate or other desired surface, rather than being initially glued together. For this example, a pick-and-place machine may be used to mount the individual discs to a substrate. The machine could apply drops of adhesive in the proper pattern and place the individual discs on the drops. If the individual discs are at the desired depth Z, the process can continue. However, if the individual discs are thicker than the desired depth Z, the individual discs of bundled rod construction may be shaved or ground to the desired depth Z. In one embodiment, the composite disc magnet may be placed onto a substrate and then shaved or ground to the desired depth Z. In one embodiment, the substrate may be a portion of a ferrite core for an energy transfer element. Further, trimming the composite disc magnet may be done before or after magnetization.

At block 420, the gaps may optionally be filled with insulating material to the outer boundary of the desired shape for the composite disc. At block 425, the composite disc of bundled rod construction is magnetized.

FIG. 4B illustrates process 403, which is one example assembly for a composite disc magnet in accordance with embodiments of the present disclosure. In particular, process 403 illustrates assembly beginning from individual rods as shown in FIGS. 1E and 2E. The order in which some or all of the process blocks appear in process 403 should not be deemed limiting. Rather, one of ordinary skill in the art having the benefit of the present disclosure will understand that some of the process blocks may be executed in a variety of orders not illustrated, or even in parallel.

The assembly starts at block 430 and proceeds to block 435 where the individual rods are gathered for assembly. Once gathered, the process proceeds to block 440 and the perimeters of the individual rods are coated with an insulating material. In one embodiment, the coating of insulated material may comprise the same or similar material to the adhesive which bonds the rods. For example, cyanoacrylate (e.g. super glue) such as for example Loctite 414 could be used for the adhesive, insulating coating and the insulating fill. In some examples, the insulating coating may comprise a lacquer, such as clear nail polish, or a polymer film, such as Parylene. Further, example process for coating the discs may include individually applying the insulating material with the appropriate tool or chemical vapor deposition of the appropriate insulating material.

At block 445 the individual rods are gathered into the desired shape of bundled rod construction. In one example, a bundled rod construction may refer to the grouping of the individual rods within an outer boundary. An example of bundled rod construction is shown with respect to FIGS. 1E and 2E. For example, the desired shape of the resultant composite disc magnet may be circular and ergo the individual rods are gathered in a bundled rod construction such that the outer boundary of the cross-section is substantially circular. The individual rods may be fastened together with glue or other adhesive material.

At block 450, the bundled rods are cut into composite discs of bundled rod construction. The bundled rods may be cut to the desired depth Z or cut to a larger thickness than the desired depth Z and then trimmed to the desired depth Z. It should be appreciated that a disc may be considered a shortened rod. In example, a rod may be considered a disc when the length of the rod is its smallest dimension. The “length” of the disc is then considered the depth. At block 455, the gaps may optionally be filled with insulating material to the outer boundary of the desired shape for the composite disc. At block 460, the composite disc of bundled rod construction is magnetized.

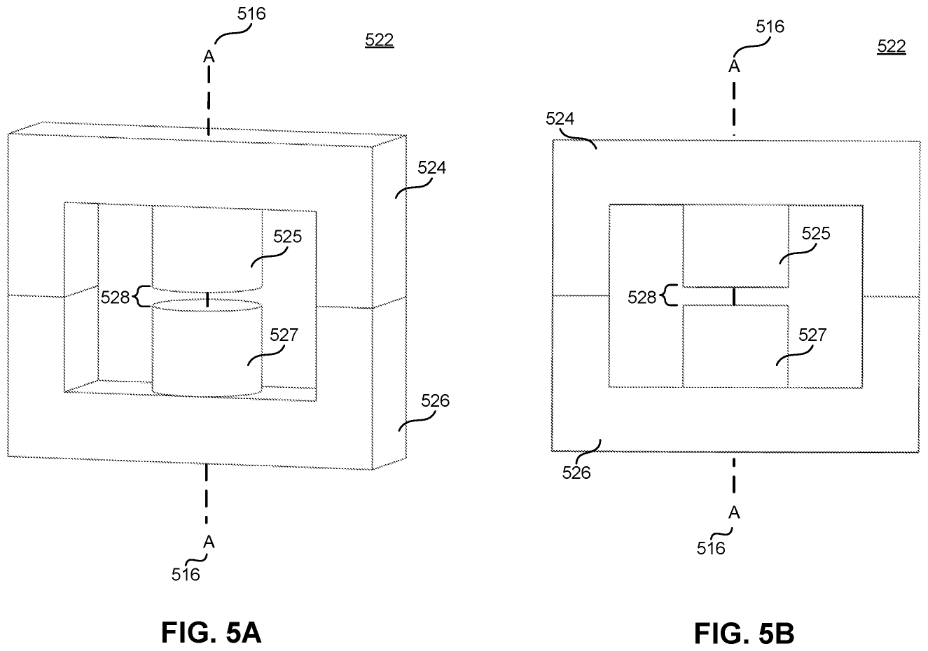

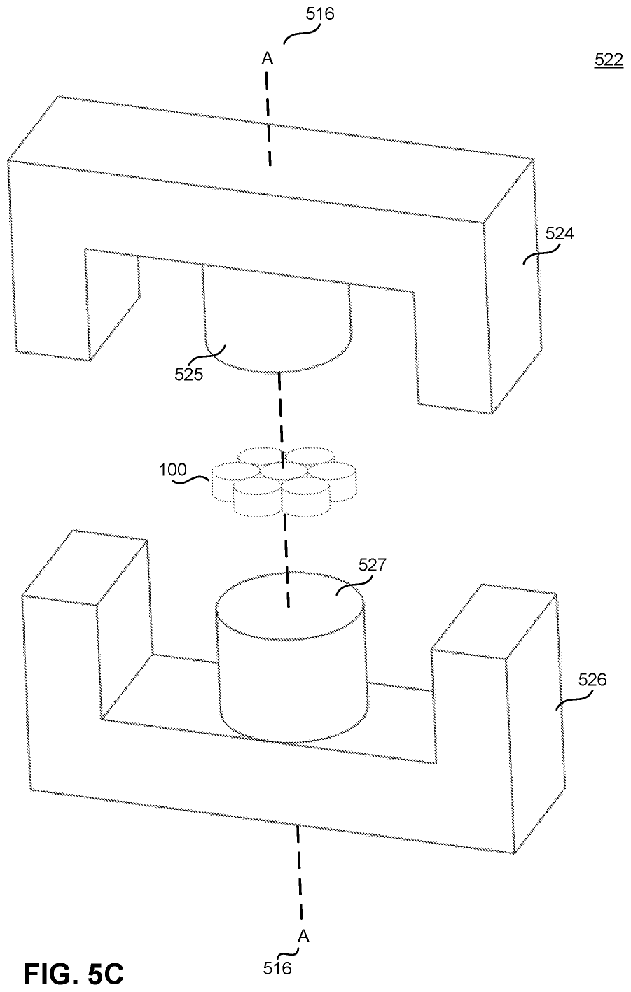

FIGS. 5A, 5B, and 5C illustrate various views of a core 522. FIG. 5A illustrates the perspective view. FIG. 5B illustrates a planar view, and FIG. 5C illustrates an exploded view of core 522. Further, FIG. 5C illustrates an exploded view of the core 522 with a composite disc magnet 100. It should be appreciated that composite disc magnet 100 is similar to the composite disc magnets discussed in this disclosure and that other embodiments of the composite disc magnet could be utilized. Further, similarly named and numbered elements may couple and function as described above. In one embodiment, the core 522 is utilized for an energy transfer element of a switched mode power converter. An energy transfer element generally includes coils of wire wound around a portion of a core 522 of magnetically active material, such as ferrite or steel. The core 522 provides a path for a magnetic field generated by an electrical current flowing through the coils of wire. The core 522 shown in FIGS. 5A, 5B, and 5C includes a first portion 524 and a second portion 526. The first portion 524 includes side posts and a center post 525. Similarly, the second portion 526 also includes side posts and a center post 527. Center posts 525 and 627 are shown as cylindrical. In other words, the face of the center posts 525, 527 are substantially circular. Central axis A 516 is shown as traversing both of the center posts 525, 527. Further, the circular face of the center posts 525, 527 is substantially perpendicular to an axis A 516. The orientation of axis A 516 shown in FIGS. 5A, 5B, and 5C is substantially similar to the axis A discussed above. In the embodiment of FIG. 5C, the axis A 516 is through the center disc of the composite disc magnet 100 and is perpendicular to the face of the center disc. As such, the composite disc magnet 100 is aligned with center posts 525, 527 of the core 522.

In one example, the core 522 shown in FIGS. 5A, 5B, and 5C is a magnetic core with circular center posts 525, 527. In an assembled energy transfer element, the center posts 525, 527 pass through a bobbin that holds coils of wire that encircle the posts. The first portion 524 is mated to the second portion 526. The assembled parts are held in place with mechanical clips or tape, and then the assembly is sealed with varnish. As shown, there is an air gap 528 between the center posts 525 and 527 of the first and second portions 524, 526, respectively. It should be appreciated that the air gap could be between either or both of the side posts of the first and second portions 524, 526. In one embodiment, the composite disc magnet 100 may be inserted into the air gap 528 between the first portion 524 and second portion 526 of the core 522. The composite disc magnet may provide flux density offset into the magnetic path of the core 522. In a further embodiment and as will be discussed below, a tiled disc magnet may be inserted into the air gap 528 to provide flux density offset into the magnetic path of the core 522.

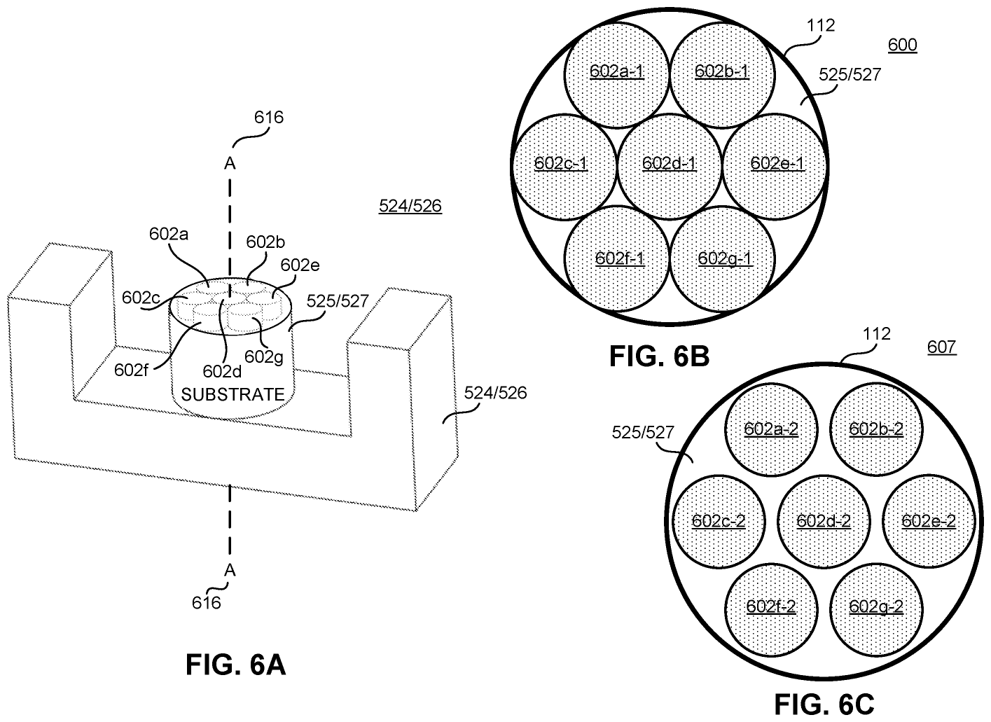

FIG. 6A illustrates a perspective view of a substrate with discs 602a, 602b, 602c, 602d, 602e, 602f, and 602g. In one example, the substrate is the surface or medium to which the composite disc magnet and/or individual discs are applied. For the example shown, either of the center posts 525, 527 of the first and second portions 524, 526 of the core 522 may be considered a substrate. As will be further discussed, the discs 602a, 602b, 602c, 602d, 602e, 602f, and 602g may be fixed to either of the center posts 525, 527. The discs 602a, 602b, 602c, 602d, 602e, 602f, and 602g may be assembled together as a composite disc magnet and/or a tiled disc magnet.

FIG. 6B is a planar view of discs 602a-1, 602b-1, 602c-1, 602d-1, 602e-1, 602f-1, and 602g-1 assembled as a composite disc magnet 600 on a substrate, such as either of center post 525 or center post 527. Discs 602a-1, 602b-1, 602c-1, 602d-1, 602e-1, 602f-1, and 602g-1 are one example of discs 602a, 602b, 602c, 602d, 602e, 602f, and 602g shown in FIG. 6A. As shown, the planar view of FIG. 6B is along axis A 616. The view shown in FIG. 6B is similar to the view shown of the composite disc magnet 100 of FIG. 1D. The discs of composite disc magnet 600 are contained within an outer boundary 112 and each is touching or otherwise contacting its neighboring disc. Further, discs 602a-1, 602b-1, 602c-1, 602d-1, 602e-1, 602f-1, and 602g-1 are attached to each other. In one example, the individual discs 602a-1, 602b-1, 602c-1, 602d-1, 602e-1, 602f-1, and 602g-1 are a composite disc magnet since the individual discs can maintain the desired pattern without additional support from a substrate or other surface. As shown, the outer boundary 112 may also be the outer edge of the substrate, such as the edge of either center post 525 or center post 527. Discs 602a-1, 602b-1, 602c-1, 602d-1, 602e-1, 602f-1, and 602g-1 are fixed atop of either center post 525 or center post 527 and within outer boundary 112. Discs 602a-1, 602b-1, 602c-1, 602d-1, 602e-1, 602f-1, and 602g-1 are shown as substantially equal in size, but it should be appreciated that smaller or larger discs may be used within the outer boundary 112.

For the example shown in FIG. 6B, discs 602a-1, 602b-1, 602c-1, 602d-1, 602e-1, 602f-1, and 602g-1 are coated with an electrically insulating material and may substantially contact a neighboring disc. In one example assembly, the discs 602a-1, 602b-1, 602c-1, 602d-1, 602e-1, 602f-1, and 602g-1 may be assembled together into a composite disc magnet 600 and then placed onto the substrate (either center posts 525, 527). In another example assembly, discs 602a-1, 602b-1, 602c-1, 602d-1, 602e-1, 602f-1, and 602g-1 may individually be placed onto the substrate (either center posts 525, 527) with a device, such as a pick-and-place machine. Optionally, the gaps between discs 602a-1, 602b-1, 602c-1, 602d-1, 602e-1, 602f-1, and 602g-1 and the outer boundary 112 may be filled with an electrically insulating fill.

FIG. 6C is also a planar view of discs 602a-2, 602b-2, 602c-2, 602d-2, 602e-2, 602f-2, and 602g-2 on a substrate, such as either of center post 525 or center post 527 assembled together as a tiled disc magnet 607. Discs 602a-2, 602b-2, 602c-2, 602d-2, 602e-2, 602f-2, and 602g-2 are one example of discs 602a, 602b, 602c, 602d, 602e, 602f, and 602g shown in FIG. 6A. As shown, the planar view of FIG. 6C is along axis A 616. FIG. 6C shares many similarities with FIG. 6B, at least one difference however is the individual discs 602a-2, 602b-2, 602c-2, 602d-2, 602e-2, 602f-2, and 602g-2 do not contact any of its neighboring discs. Since the discs 602a-2, 602b-2, 602c-2, 602d-2, 602e-2, 602f-2, and 602g-2 do not contact each other, they may optionally be coated with an electrically insulating material. In one embodiment, the tiled disc magnet 607 could include a plurality of discs (such as discs 602a-2, 602b-2, 602c-2, 602d-2, 602e-2, 602f-2, and 602g-2) and a substrate. It should be appreciated that the individual discs of a tiled disc magnet may comprise similar materials as the individual discs of a composite disc magnet, however, the individual discs of a tiled disc magnet do not necessarily contact its neighboring discs. In an example assembly, discs 602a-2, 602b-2, 602c-2, 602d-2, 602e-2, 602f-2, and 602g-2 may individually be placed onto the substrate (either center posts 525, 527) with a device, such as a pick-and-place machine. The pick-and-place machine may align discs 602a-2, 602b-2, 602c-2, 602d-2, 602e-2, 602f-2, and 602g-2 such that they are not contacting each other. In other words, the discs 602a-2, 602b-2, 602c-2, 602d-2, 602e-2, 602f-2, and 602g-2 may be tiled onto the substrate and may be referred to as a tiled disc magnet 607. Optionally, the gaps between discs 602a-2, 602b-2, 602c-2, 602d-2, 602e-2, 602f-2, and 602g-2 and the outer boundary 112 may be filled with an electrically insulating fill.

In one embodiment, if the individual discs can maintain the tiled pattern without the substrate, the individual discs may be considered a composite disc magnet. For example, individual discs 602a-2, 602b-2, 602c-2, 602d-2, 602e-2, 602f-2, and 602g-2 may not be touching or otherwise contacting its neighboring discs but an electrically insulating fill allows the individual discs to keep the desired pattern. As such, the individual discs 602a-2, 602b-2, 602c-2, 602d-2, 602e-2, 602f-2, and 602g-2 may be considered a composite disc magnet.

FIG. 7 illustrates a process 700, which is one example assembly for a composite disc magnet or a tiled disc magnet onto a substrate, such as a portion of a core. The order in which some or all of the process blocks appear in process 700 should not be deemed limiting. Rather, one of ordinary skill in the art having the benefit of the present disclosure will understand that some of the process blocks may be executed in a variety of orders not illustrated, or even in parallel. The assembly starts at block 701 and proceeds to block 705 where the individual discs and the substrate are gathered for assembly. Once gathered, the process proceeds to block 710 and an adhesive is placed onto the substrate into the desired pattern for the individual discs. Or in other words, an adhesive is placed onto the substrate into the desired pattern for the composite disc magnet or the tiled disc magnet. Examples for the adhesive could include cyanoacrylate (e.g. super glue) such as for example Loctite 414, however other adhesives could also be used.

At block 715, the individual discs are mounted and adhered to the substrate in the desired pattern. For this example, a pick-and-place machine may be used to mount the individual discs to a substrate. The machine could apply drops of adhesive in the desired pattern and place the individual discs on the drops of adhesive. In one embodiment, the adhesive may be placed in the desired pattern such that the individual discs contact or otherwise touch each other into a composite disc magnet. In another embodiment, the adhesive may be placed in the desired pattern such that the individual discs do not contact or otherwise touch each other into a tiled disc magnet. The perimeters of the individual discs may be coated with an electrically insulating material. In one embodiment, the coating of electrically insulated material may comprise the same or similar material to the adhesive which bonds the discs to the substrate. In some examples, the insulating coating may comprise a lacquer, such as clear nail polish, or a polymer film, such as Parylene. Further, an example process for coating the discs may include individually applying the insulating material with the appropriate tool or chemical vapor deposition of the appropriate insulating material. However, the discs may be placed such that they do not touch or otherwise contact each other and as such the insulating coating may be optional.

If the individual discs are at the desired depth Z, the process can continue. However, if the individual discs are thicker than the desired depth Z, the individual discs may be shaved or ground to the desired depth Z. In one example, the individual discs may be shaved or ground either before or after placement onto the substrate.

At block 720, the gaps may optionally be filled with insulating material. In one example, the gaps between the discs may be filled with insulating material. In another example, the gaps may be further filled to the outer boundary of the substrate. At block 725, the discs are magnetized.

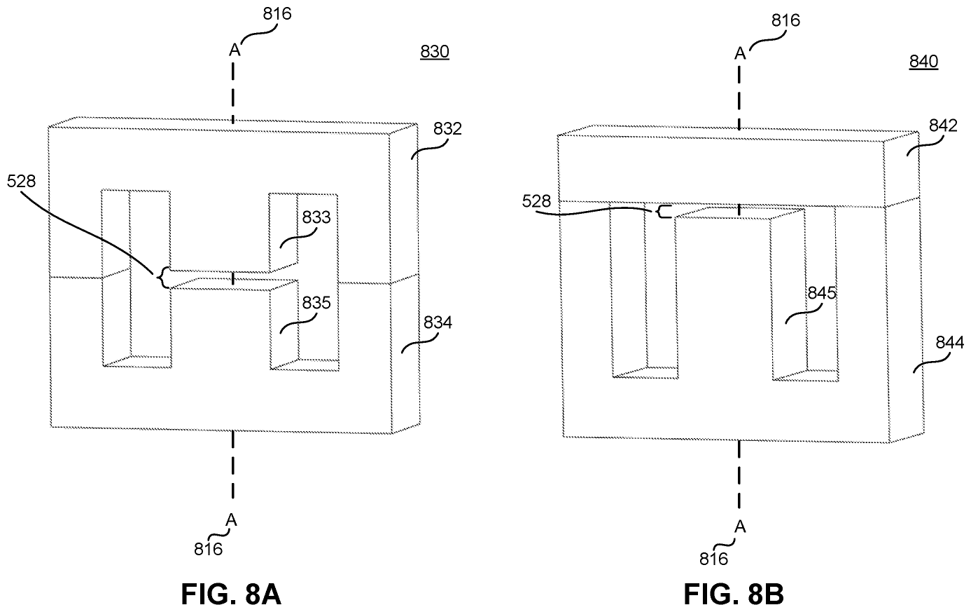

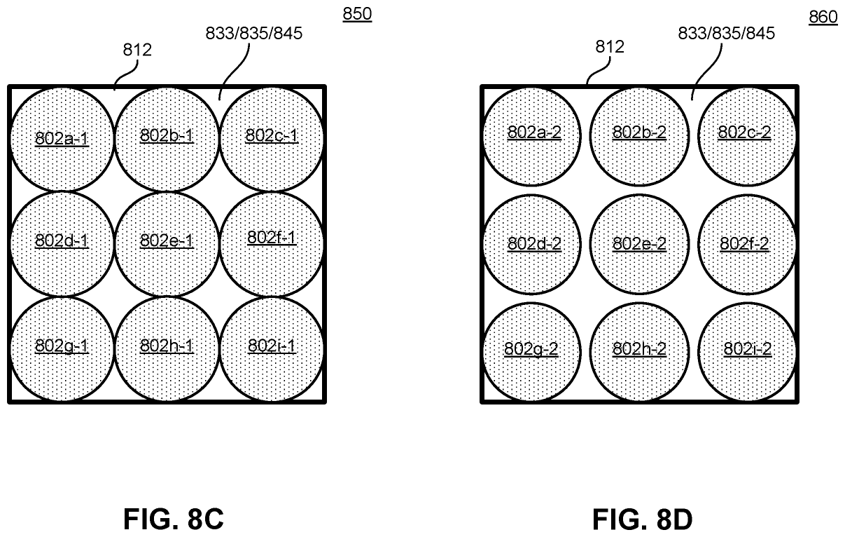

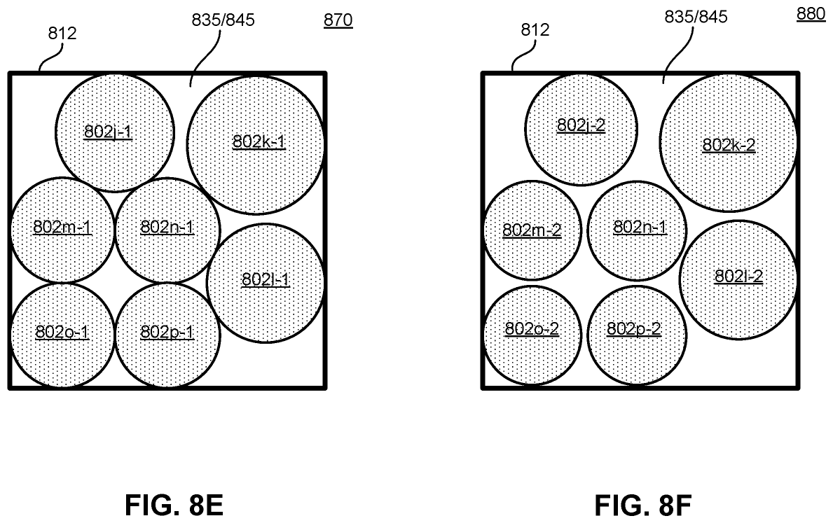

FIG. 8A illustrates a perspective view of another example core 830. Core 830 is another example core which may be utilized for an energy transfer element of a switched mode power converter. The core 830 shown in FIGS. 8A includes a first portion 832 and a second portion 834. The first portion 832 includes side posts and a center post 833. Similarly, the second portion 834 also includes side posts and a center post 835. It should be appreciated that core 830 shares many similarities with core 522, at least one difference however is the face of the center posts 833 and 835 is substantially square.

Central axis 816 is shown as traversing both of the center posts 833, 835 and the square face of the center posts 833, 835 is substantially perpendicular with axis A 816. The core 830 shown in FIG. 8A is an EE core with square center posts 833, 835. It may be assembled in the same way as the cores with a circular center post in FIGS. 5A, 5B, and 5C. As shown, there is an air gap 528 between the center posts 833, 835 of the first and second portions 832, 834, respectively. In one embodiment, the composite disc magnet or a tiled disc magnet may be inserted or otherwise placed into the air gap 528 between the first portion 832 and second portion 834 of the core 830.

FIG. 8B illustrates a perspective view of another example core 840. Core 840 is another example core which may be utilized for an energy transfer element of a switched mode power converter. The core 840 shown in FIGS. 8B includes a first portion 842 and a second portion 844. Core 840 is similar to core 830 shown with respect to FIG. 8A, however at least one difference is the first portion 842 of core 840 does not have side or center posts. As shown the first portion 842 may be a bar. The second portion 844 includes side posts and a center post 845. The core 840 shown in FIG. 8B is an EI core with a square shaped center post 845. It may be assembled in the same way as the cores with a circular center post in FIGS. 5A, 5B, and 5C. As shown, there is an air gap 528 between the center post 845 and the first portion 842. In one embodiment, the composite disc magnet or the tiled disc magnet may be inserted into the air gap 528 between the center post of the second portion 844 and the first portion 842.

FIG. 8C is planar view individual circular discs 802a-1, 802b-1, 802c-1, 802d-1, 802e-1, 802f-1, 802g-1, 802h-1, and 802i-1 assembled together as a composite disc magnet 850 placed on the face of either center posts 833, 835 or 845 of FIGS. 8A and 8B. As shown, the planar view of FIG. 8C is along axis A 816. Discs 802a-1, 802b-1, 802c-1, 802d-1, 802e-1, 802f-1, 802g-1, 802h-1, and 802i-1 are contained within an outer boundary 812 and are touching or otherwise contacting its neighboring disc. Further, discs 802a-1, 802b-1, 802c-1, 802d-1, 802e-1, 802f-1, 802g-1, 802h-1, and 802i-1 are attached to each other. In one example, the individual discs 802a-1, 802b-1, 802c-1, 802d-1, 802e-1, 802f-1, 802g-1, 802h-1, and 802i-1 may be considered a composite disc magnet since the individual discs can maintain the desired pattern without additional support from a substrate or other surface. In one example, outer boundary 812 may also be the outer edge of the face of either center posts 833, 835 or 845. As shown, the outer boundary 812 is substantially a square. Discs 802a-1, 802b-1, 802c-1, 802d-1, 802e-1, 802f-1, 802g-1, 802h-1, and 802i-1 are shown as substantially equal in size, but it should be appreciated that smaller or larger discs may be used within the outer boundary 812.

For the example shown in FIG. 8C, discs 802a-1, 802b-1, 802c-1, 802d-1, 802e-1, 802f-1, 802g-1, 802h-1, and 802i-1 are coated with an electrically insulating material and may substantially contact a neighboring disc. In one example assembly, the discs 802a-1, 802b-1, 802c-1, 802d-1, 802e-1, 802f-1, 802g-1, 802h-1, and 802i-1 may be assembled together into a composite disc magnet 850 and then placed onto the substrate (either center posts 833, 835, or 845). In another example assembly, discs 802a-1, 802b-1, 802c-1, 802d-1, 802e-1, 802f-1, 802g-1, 802h-1, and 802i-1 may individually be placed onto the substrate (either center posts 833, 835, or 845) with a device, such as a pick-and-place machine. Optionally, the gaps between discs 802a-1, 802b-1, 802c-1, 802d-1, 802e-1, 802f-1, 802g-1, 802h-1, and 802i-1 and the outer boundary]812 may be filled with an electrically insulating fill.

FIG. 8D is also a planar view of individual circular discs 802a-2, 802b-2, 802c-2, 802d-2, 802e-2, 802f-2, 802g-2, 802h-2, and 802i-2 placed on the face of either center posts 833, 835 or 845 of FIGS. 8A and 8B and assembled together as a tiled disc magnet 860. It should be appreciated that discs 802a-2, 802b-2, 802c-2, 802d-2, 802e-2, 802f-2, 802g-2, 802h-2, and 802i-2 share many similarities with discs 802a-1, 802b-1, 802c-1, 802d-1, 802e-1, 802f-1, 802g-1, 802h-1, and 802i-1 of FIG. 8C and are therefore numbered accordingly. As shown, the planar view of FIG. 8D is also along axis A 816. At least one difference, however, is the individual discs 802a-2, 802b-2, 802c-2, 802d-2, 802e-2, 802f-2, 802g-2, 802h-2, and 802i-2 do not contact any neighboring discs. In one embodiment, the tiled disc magnet 860 could include a plurality of discs (such as discs 802a-2, 802b-2, 802c-2, 802d-2, 802e-2, 802f-2, 802g-2, 802h-2, and 802i-2) and a substrate. Since the discs 802a-2, 802b-2, 802c-2, 802d-2, 802e-2, 802f-2, 802g-2, 802h-2, and 802i-2 do not contact each other, the electrically insulating coating of each disc may be optional. In the example shown, discs 802a-2, 802b-2, 802c-2, 802d-2, 802e-2, 802f-2, 802g-2, 802h-2, and 802i-2 are placed to the outer boundary 812, however it should be appreciated that there may be a gap between the outer boundary 812 and the discs.

In an example assembly, discs 802a-2, 802b-2, 802c-2, 802d-2, 802e-2, 802f-2, 802g-2, 802h-2, and 802i-2 may individually be placed onto the substrate (either center posts 833, 835, or 845) with a device, such as a pick-and-place machine. The pick-and-place machine would align discs 802a-2, 802b-2, 802c-2, 802d-2, 802e-2, 802f-2, 802g-2, 802h-2, and 802i-2 such that they are not contacting each other. In other words, the discs 802a-2, 802b-2, 802c-2, 802d-2, 802e-2, 802f-2, 802g-2, 802h-2, and 802i-2 may be tiled onto the substrate and may be referred to as a tiled disc magnet 860. Optionally, the gaps between discs 802a-2, 802b-2, 802c-2, 802d-2, 802e-2, 802f-2, 802g-2, 802h-2, and 802i-2 and the outer boundary 812 may be filled with an electrically insulating fill.

In one embodiment, if the individual discs can maintain the tiled pattern without the substrate, the individual discs may be considered a composite disc magnet. For example, individual discs 802a-2, 802b-2, 802c-2, 802d-2, 802e-2, 802f-2, 802g-2, 802h-2, and 802i-2 may not be touching or otherwise contacting its neighboring discs but an electrically insulating fill allows the individual discs to keep the desired pattern. As such, the individual discs 802a-2, 802b-2, 802c-2, 802d-2, 802e-2, 802f-2, 802g-2, 802h-2, and 802i-2 may be considered a composite disc magnet.

FIG. 8E is planar view of a further example of a composite disc magnet 870 of individual circular discs 802j-1, 802k-1, 802l-1, 802m-1, 802n-1, 802o-1, and 802p-1 placed on the square shaped face of either center posts 833, 835 or 845 of FIGS. 8A and 8B. Discs 802j-1, 802k-1, 802l-1, 802m-1, 802n-1, 802o-1, and 802p-1 are contained within an outer boundary 812 and are contacting or otherwise touching its neighboring discs. Further, discs 802j-1, 802k-1, 802l-1, 802m-1, 802n-1, 802o-1, and 802p-1 are attached to each other such that the discs can maintain the desired pattern without the use of a substrate. The pattern of the individual discs is less regular than previous patterns shown. Discs 802m-1, 802n-1, 802o-1, and 802p-1 are substantially patterned into a square and are similar in size. Discs 102a and 102c are similar in size and larger than discs 102d, 102e, 102f, and 102g. Further, discs 802j-1 and 802l-1 are placed between the outer boundary 812 and discs 802m-1, 802n-1 or the outer boundary 812 and discs 802n-1, 802p-1, respectively. Disc 802k-1 as shown is larger than discs 802j-1, 802j-1 and is placed between the outer boundary 812 and disc 802n-1. As such, the example composite disc magnet 870 and/or tiled magnet 880 shown in FIGS. 8E and 8F have discs of various sizes and an irregular pattern. For the example shown in FIG. 8E, discs 802j-1, 802k-1, 802l-1, 802m-1, 802n-1, 802o-1, and 802p-1 are coated with an electrically insulating material and may substantially contact a neighboring disc.

FIG. 8F is also a planar view of individual circular discs 802j-2, 802k-2, 802l-2, 802m-2, 802n-2, 802o-2, and 802p-2 placed on the face of either center posts 833, 835 or 845 of FIGS. 8A and 8B and assembled together as a tiled disc magnet 880. It should be appreciated that discs 802j-2, 802k-2, 8021-2, 802m-2, 802n-2, 802o-2, and 802p-2 of FIG. 8F share many similarities with discs 802j-1, 802k-1, 802l-1, 802m-1, 802n-1, 802o-1, and 802p-1 of FIG. 8E and are numbered accordingly. At least one difference, however, is the individual discs 802j-2, 802k-2, 802l-2, 802m-2, 802n-2, 802o-2, and 802p-2 do not contact any of its neighboring discs. Since the discs 802j-2, 802k-2, 802l-2, 802m-2, 802n-2, 802o-2, and 802p-2 do not contact each other, the insulating coating for each disc may be optional. In one embodiment, the tiled disc magnet 880 could include a plurality of discs (such as discs 802j-2, 802k-2, 8021-2, 802m-2, 802n-2, 802o-2, and 802p-2) and a substrate.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

Although the present invention is defined in the claims, it should be understood that the present invention can alternatively be defined in accordance with the following examples:

### EXAMPLE 1

A magnet comprising a center disc having a center disposed as a center of the magnet, a face of the center disc substantially perpendicular to a central axis of the magnet; and a first plurality of outer discs disposed around the center disc in a bundled rod construction, a face of each of the first plurality of outer discs substantially perpendicular to the central axis of the magnet, wherein the center disc and each disc of the first plurality of outer discs is electrically insulated from every other disc.

### EXAMPLE 2

The magnet of example 1, wherein a depth of the center disc and a depth of each of the first plurality of outer discs are substantially the same.

### EXAMPLE 3

The magnet of examples 1 or 2, wherein a size of the center disc and a size of each of the first plurality of outer discs are substantially the same.

### EXAMPLE 4

The magnet of any one of examples 1 to 3, wherein a shape of the center disc and a shape of each of the first plurality of outer discs are substantially the same shape.

### EXAMPLE 5

The magnet of any one of examples 1 to 4, wherein the shape is substantially a circle.

### EXAMPLE 6

The magnet of any one of examples 1 to 5, wherein the shape is substantially a hexagon.

### EXAMPLE 7

The magnet of any one of examples 1 to 6, wherein the center disc and each of the first plurality of outer discs are within an outer boundary of the magnet.

### EXAMPLE 8

The magnet of any one of examples 1 to 7, wherein gaps exist between the center disc and each of the first plurality of outer discs, and between each of the first plurality of outer discs and the outer boundary, and the gaps are filled with an insulating fill.

### EXAMPLE 9

The magnet of any one of examples 1 to 8, wherein a shape of the outer boundary, the center disc, and each of the first plurality of outer discs is substantially a circle, and wherein a diameter of the outer boundary is greater than a diameter of the center disc and each of the first plurality of outer discs.

### EXAMPLE 10

The magnet of any one of examples 1 to 9, wherein the diameter of the outer boundary is three times the diameter of the center disc and three times the diameter of each of the first plurality of outer discs.

### EXAMPLE 11

The magnet of any one of examples 1 to 10, further comprising:

a second plurality of outer discs disposed around the center disc in the bundled rod construction with the center disc and each of the first plurality of outer discs, a face of each of the second plurality of outer discs substantially perpendicular to the central axis of the magnet, each disc of the first plurality of outer discs, and each disc of the second plurality of outer discs are electrically insulated from every other disc.

### EXAMPLE 12

The magnet of any one of examples 1 to 11, wherein a shape of the outer boundary, the center disc, each of the first plurality of outer discs, and each of the second plurality of outer discs is substantially a circle, wherein: a diameter of the outer boundary is greater than a diameter of the center disc and greater than a diameter of each of the first plurality of outer discs, and greater than a diameter of each of the second plurality of outer discs, and the diameter of the center disc and the diameter of each of the first plurality of outer discs are greater than the diameter of each of the second plurality of outer discs.

### EXAMPLE 13

The magnet of any one of examples 1 to 12, wherein the center disc, each of the first plurality of outer discs, and each of the second plurality of outer discs are coated with an insulating material.

### EXAMPLE 14

The magnet of any one of examples 1 to 13, wherein the center disc and each of the first plurality of outer discs are coated with an insulating material.

### EXAMPLE 15

A magnet comprising an outer boundary; and a first plurality of discs disposed within the outer boundary in a bundled rod construction, wherein a surface of each of the first plurality of discs is substantially perpendicular to a central axis of the magnet, and wherein each disc of the first plurality of discs is electrically insulated from every other disc in the first plurality of discs.

### EXAMPLE 16

The magnet of example 15, wherein a depth of each of the first plurality of discs is substantially the same.

### EXAMPLE 17

The magnet of example 15 or 16, wherein a size of each of the first plurality of discs is substantially the same.

### EXAMPLE 18

The magnet of any one of examples 15 to 17, wherein a shape of each of the first plurality of discs is substantially the same shape.

### EXAMPLE 19

The magnet of any one of examples 15 to 18, wherein the shape is substantially a circle.

### EXAMPLE 20

The magnet of any one of examples 15 to 19, wherein the shape is substantially a hexagon.

### EXAMPLE 21

The magnet of any one of examples 15 to 20, wherein the shape is substantially a triangle.

### EXAMPLE 22

The magnet of any one of examples 15 to 21, wherein the shape is substantially a pie-shape.

### EXAMPLE 23

The magnet of any one of examples 15 to 22, wherein gaps exist between each of the first plurality of discs and the outer boundary and the gaps are filled with an insulating fill.

### EXAMPLE 24

The magnet of any one of examples 15 to 23, wherein the first plurality of discs includes at least two different shapes.

### EXAMPLE 25

The magnet of any one of examples 15 to 24, further comprising a second plurality of discs disposed within the outer boundary in the bundled rod construction, wherein a face of each of the second plurality of discs is substantially perpendicular to the central axis, and wherein each disc of the second plurality of discs and each disc of the first plurality of discs are electrically insulated from every other disc.

### EXAMPLE 26

The magnet of any one of examples 15 to 25, wherein a size of each disc of the first plurality of discs is substantially the same and a size of each disc of the second plurality of discs is substantially the same, the size of each disc of the first plurality of discs being different from the size of each disc of the second plurality of discs.

### EXAMPLE 27

The magnet of any one of examples 15 to 26, wherein each disc of the first plurality of discs, and each disc of the second plurality of discs are coated with an insulating material.

### EXAMPLE 28

The magnet of any one of examples 15 to 27, wherein each of the first plurality of discs is coated with an insulating material.

### EXAMPLE 29

A method of constructing a composite disc magnet, comprising gathering a plurality of discs of magnetizable material; coating a perimeter of the plurality of discs with an insulating material; attaching the plurality of discs to each other into a desired shape, wherein a face of the plurality of discs is substantially perpendicular with a central axis of the composite disc magnet; and magnetizing the plurality of discs.

### EXAMPLE 30

The method of example 30, further comprising trimming a depth of each of the plurality of discs.

### EXAMPLE 31

The method of example 29 or 30, further comprising filling gaps between the plurality of discs and an outer boundary of the composite disc magnet with an insulating fill.

### EXAMPLE 32

The method of any one of examples 29 to 31, wherein the attaching the plurality of discs into the desired shape further comprises attaching the plurality of discs into the desired shape on a substrate.

### EXAMPLE 33

A method of constructing a composite disc magnet, comprising gathering a plurality of rods of magnetizable material; coating a perimeter of the plurality of rods with an insulating material; attaching the plurality of rods to each other such that a cross-section of the plurality of rods is substantially a desired shape, wherein the cross-section of the plurality of rods is substantially perpendicular with a central axis of the composite disc magnet; cutting the plurality of rods into composite disc slices with a depth; and magnetizing the composite disc slices.

### EXAMPLE 34

The method of example 33, further comprising filling gaps between the composite disc slices and an outer boundary of the composite disc magnet with an insulating fill.

### EXAMPLE 35

The method of example 33 or 34, further comprising trimming a depth of the composite disc slices.

### EXAMPLE 36

A method for constructing a magnet onto a substrate, comprising gathering a plurality of discs of magnetizable material; gathering a substrate; placing an adhesive material onto the substrate into a desired pattern; attaching the plurality of discs to the adhesive material in the desired pattern to the substrate, wherein a face of the plurality of discs is substantially perpendicular to a central axis of the magnet; and magnetizing the plurality of discs.

### EXAMPLE 37

The method of example 36, further comprising coating a perimeter of the plurality of discs with an insulating material.

### EXAMPLE 38

The method of example 36 or 27, further comprising trimming a depth of the plurality of discs.

### EXAMPLE 39

The method of any one of examples 36 to 38, further comprising filling gaps between the plurality of discs and an outer boundary of the substrate with an insulating fill.

### EXAMPLE 40

The method of any one of examples 36 to 39, wherein attaching the plurality of discs the substrate, further comprising attaching the plurality of discs with a pick-and-place machine.

### EXAMPLE 41

An energy transfer element for a power converter, comprising a composite disc magnet, the composite disc magnet comprising a first plurality of discs, a face of each of the first plurality of discs is substantially perpendicular to a central axis of the composite disc magnet; and a core of magnetically active material, the core comprising: a first portion; a second portion; and an air gap between the first portion and the second portion, the composite disc magnet housed in the air gap between the first portion and the second portion of the core.

### EXAMPLE 42

The energy transfer element of example 41 further comprising coils of wire.

### EXAMPLE 43

The energy transfer element of example 41 or 42, further comprising a bobbin.

### EXAMPLE 44

The energy transfer element of any one of examples 41 to 43, the first plurality of discs disposed around the central axis of the composite disc magnet in a bundled rod construction and each disc of the plurality of discs is electrically insulated from every other disc.

### EXAMPLE 45

The energy transfer element of any one of examples 41 to 44, wherein a depth of each of the first plurality of discs is substantially the same.

### EXAMPLE 46

The energy transfer element of any one of examples 41 to 45, wherein a size of each of the first plurality of discs is substantially the same.

### EXAMPLE 47

The energy transfer element of any one of examples 41 to 46, wherein a shape of each of the first plurality of discs is substantially the same shape.

### EXAMPLE 48

The energy transfer element of any one of examples 41 to 47, wherein the second portion of the core further comprises a center post, and the composite disc magnet is substantially positioned onto the center post and within an outer boundary of the center post.

### EXAMPLE 49

The energy transfer element of any one of examples 41 to 48, wherein gaps between each of the first plurality of discs and the outer boundary are filled with an insulating fill.

### EXAMPLE 50

The energy transfer element of any one of examples 41 to 49, wherein each of the first plurality of discs is coated with an insulating material.

### EXAMPLE 51

A tiled disc magnet, comprising a substrate with a surface; and a plurality of discs disposed on the surface of the substrate, wherein a face of each of the plurality of discs are substantially parallel with the surface of the substrate and each disc of the plurality of discs does not contact any other disc.

### EXAMPLE 52

The tiled disc magnet of example 51, wherein a depth of each disc in the plurality of discs is substantially the same.

### EXAMPLE 53

The tiled disc magnet of example 51 or 52, wherein a size of each disc in the plurality of discs is substantially the same.

### EXAMPLE 54

The tiled disc magnet of any one of examples 51 to 53, wherein a size of at least one disc in the plurality of discs is not substantially the same as a size of another disc in the plurality of discs.

### EXAMPLE 55

The tiled disc magnet of any one of examples 51 to 54, wherein a shape of each disc in the plurality of discs is substantially the same shape.

### EXAMPLE 56

The tiled disc magnet of any one of examples 51 to 55, wherein the shape is substantially a circle.

### EXAMPLE 57

The tiled disc magnet of any one of examples 51 to 56, wherein the shape is substantially a hexagon.

### EXAMPLE 58

The tiled disc magnet of any one of examples 51 to 57, wherein the plurality of discs are within an outer boundary of the tiled disc magnet.

### EXAMPLE 59

The tiled disc magnet of any one of examples 51 to 58, wherein gaps between the plurality of discs is filled with an insulating fill.

### EXAMPLE 60

The tiled disc magnet of any one of examples 51 to 59, wherein the plurality of discs comprises at least two shapes.

### EXAMPLE 61

The tiled disc magnet of any one of examples 51 to 60, each of the plurality of discs is coated with an insulating material.

What is claimed is:

1. A magnet comprising:
a center disc having a center disposed as a center of the magnet, a face of the center disc substantially perpendicular to a central axis of the magnet; and
a first plurality of outer discs disposed around the center disc in a bundled rod construction, a face of each of the first plurality of outer discs substantially perpendicular to the central axis of the magnet, wherein the center disc and each disc of the first plurality of outer discs is electrically insulated from every other disc.

2. The magnet of claim 1, wherein a depth of the center disc and a depth of each of the first plurality of outer discs are substantially the same.

3. The magnet of claim 1, wherein a size of the center disc and a size of each of the first plurality of outer discs are substantially the same.

4. The magnet of claim 1, wherein a shape of the center disc and a shape of each of the first plurality of outer discs are substantially the same shape.

5. The magnet of claim 4, wherein the shape is substantially a circle.

6. The magnet of claim 4, wherein the shape is substantially a hexagon.

7. The magnet of claim 1, wherein the center disc and each of the first plurality of outer discs are within an outer boundary of the magnet.

8. The magnet of claim 7, wherein gaps exist between the center disc and each of the first plurality of outer discs, and between each of the first plurality of outer discs and the outer boundary, and the gaps are filled with an insulating fill.

9. The magnet of claim 7, wherein a shape of the outer boundary, the center disc, and each of the first plurality of outer discs is substantially a circle, and wherein a diameter of the outer boundary is greater than a diameter of the center disc and each of the first plurality of outer discs.

10. The magnet of claim 9, wherein the diameter of the outer boundary is three times the diameter of the center disc and three times the diameter of each of the first plurality of outer discs.

11. The magnet of claim 7, further comprising:
a second plurality of outer discs disposed around the center disc in the bundled rod construction with the center disc and each of the first plurality of outer discs, a face of each of the second plurality of outer discs substantially perpendicular to the central axis of the magnet, each disc of the first plurality of outer discs, and each disc of the second plurality of outer discs are electrically insulated from every other disc.

12. The magnet of claim 11, wherein a shape of the outer boundary, the center disc, each of the first plurality of outer discs, and each of the second plurality of outer discs is substantially a circle, wherein:
a diameter of the outer boundary is greater than a diameter of the center disc and greater than a diameter of each of the first plurality of outer discs, and greater than a diameter of each of the second plurality of outer discs, and
the diameter of the center disc and the diameter of each of the first plurality of outer discs are greater than the diameter of each of the second plurality of outer discs.

13. The magnet of claim 11, wherein the center disc, each of the first plurality of outer discs, and each of the second plurality of outer discs are coated with an insulating material.

14. The magnet of claim 1, wherein the center disc and each of the first plurality of outer discs are coated with an insulating material.

15. An energy transfer element for a power converter, comprising:
a composite disc magnet, the composite disc magnet comprising a first plurality of discs, a face of each of the first plurality of discs is substantially perpendicular to a central axis of the composite disc magnet; and
a core of magnetically active material, the core comprising:
a first portion;
a second portion; and
an air gap between the first portion and the second portion, the composite disc magnet housed in the air gap between the first portion and the second portion of the core.

16. The energy transfer element of claim 15 further comprising coils of wire.

17. The energy transfer element of claim 15, further comprising a bobbin.

18. The energy transfer element of claim 15, the first plurality of discs disposed around the central axis of the composite disc magnet in a bundled rod construction and each disc of the plurality of discs is electrically insulated from every other disc.

19. The energy transfer element of claim 15, wherein a depth of each of the first plurality of discs is substantially the same.

20. The energy transfer element of claim 15, wherein a size of each of the first plurality of discs is substantially the same.

21. The energy transfer element of claim 15, wherein a shape of each of the first plurality of discs is substantially the same shape.

22. The energy transfer element of claim 15, wherein the second portion of the core further comprises a center post, and the composite disc magnet is substantially positioned onto the center post and within an outer boundary of the center post.

23. The energy transfer element of claim 22, wherein gaps between each of the first plurality of discs and the outer boundary are filled with an insulating fill.

24. The energy transfer element of claim 18, wherein each of the first plurality of discs is coated with an insulating material.
